(19) United States
(12) Patent Application Publication
(10) Pub. No.: US 2004/0139020 A1
(43) Pub. Date: Jul. 15, 2004

(54) Authentication apparatus and authentication system

(76) Inventor: Shuji Ono, Kanagawa (JP)

Correspondence Address: BIRCH STEWART KOLASCH & BIRCH, PO BOX 747, FALLS CHURCH, VA, 22040-0747, US

(21) Appl. No.: 10/733,400

(22) Filed: Dec. 12, 2003

(30) Foreign Application Priority Data
Jan. 10, 2003 (JP) 2003-005111

(51) Int. Cl. G06F 17/60

(52) U.S. Cl. 705/44

(57) ABSTRACT

Improper person cannot pretend to be and behave like the right person without the use of a password. Authentication apparatus comprises an authentication information receiving unit for receiving an authentication information held by each of a plurality of articles for authentication from each of the plurality of articles for authentication carried by a right person, and at the same time communicating with at least one article for authentication by radio, and a personal authentication unit for performing the personal authentication process using the plurality of authentication information received by the authentication information receiving unit. The article for authentication is, for example, an IC card and an IC tag attached to a portable article carried by the right person.

The present application claims priority from a Japanese Patent Application No. 2003-005111 filed on Jan. 10, 2003, the contents of which are incorporated herein by reference.

### BACKGROUND OF THE INVENTION

1. Field of the Invention

The present invention relates to an authentication apparatus and an authentication system for certifying the right person by means of an article for authentication of a portable recording medium etc. More particularly, the present invention relates to an authentication apparatus and an authentication system capable of preventing that improper person pretends to be the right person even when improper person acquired an article for authentication.

2. Description of the Related Art

In order to manage entrance management information and secret information, a personal authentication may be performed using portable recording media such as a magnetic card or an IC card. In this personal authentication technology, the portable recording media previously hold an authentication key for use in the personal authentication. And then, the right person who should be certified lets an authentication apparatus to read out the portable recording media. The authentication apparatus inquires an authentication key read from the portable recording media with the previously registered authentication key, and certifies that the occupier of the portable recording media is the right person when two authentication keys are identical. For details, refer to, for example, Japanese Patent Applications Laid-Open Nos. 2002-92495 and 2001-36895.

When improper person acquired the portable recording media that hold the authentication key, improper person can pretend to be and behave like the right person. A password can be used in order to prevent this. However, in this case, the right person has to memorize the password, and thus this was burden to the right person.

### SUMMARY OF THE INVENTION

Therefore, it is an object of the present invention to provide an authentication apparatus and an authentication system which can solve the foregoing problems. The above and other objects can be achieved by combinations described in the independent claims. The dependent claims define further advantageous and exemplary combinations of the present invention.

According to the first aspect of the present invention, there is provided an authentication apparatus for performing a personal authentication process. The authentication apparatus includes: an authentication information receiving unit for receiving an authentication information held by each of a plurality of articles for authentication from each of the plurality of articles for authentication carried by a right person, and at the same time communicating with at least one article for authentication by radio; and a personal authentication unit for performing the personal authentication process using the plurality of authentication information received by the authentication information receiving unit.

In the first aspect, the authentication apparatus may further include an authentication information holding unit for previously holding weight coefficients showing weights of the authentication information in response to each of the plurality of authentication information, the personal authentication unit may acquire the weight coefficient corresponding to the received authentication information from the authentication information holding unit, and certify the right person when a sum of the acquired weight coefficients is greater than a predetermined reference value.

The personal authentication unit may decide differently the reference value according to an object of the personal authentication.

The personal authentication unit may certify the right person when the value of the received authentication information is more than the predetermined reference number.

The personal authentication unit may decide the reference number according to an object of the personal authentication.

One of the plurality of articles for authentication may hold an identification information identifying the right person as the authentication information.

The plurality of articles for authentication may include a main article and a plurality of assistant articles, the plurality of assistant articles may hold the same authentication information, the personal authentication unit may certify the right person when receiving the authentication information from the main article and the authentication information from any one of the assistant articles.

According to the second aspect of the present invention, there is provided an authentication system. The authentication system includes: a plurality of articles for authentication carried by a right person and used to certify the right person; and an authentication apparatus for performing a personal authentication process, each article for authentication holds different authentication information, the authentication apparatus includes a personal authentication unit for receiving the plurality of authentication information held by the plurality of articles for authentication and certifying the personal himself using the received plurality of authentication information.

In the authentication system, at least one of the articles for authentication may transmit the authentication information to the authentication apparatus by radio using an energy by an electromagnetic wave acquired from outside.

One of the articles for authentication may include an authentication key generating unit for receiving the authentication information held by that article for authentication from the other articles for authentication, and generating an authentication key for the personal authentication based upon the received authentication information and the authentication information held by that article for authentication in advance, the personal authentication unit of the authentication apparatus may receive the authentication key from the article for authentication that has generated the authentication key, and certify the right person using the authentication key.

The article for authentication may generate a decoding key for decoding an encoded information using the authentication key, the personal authentication unit may perform a decoding process using the decoding key.

The summary of the invention does not necessarily describe all necessary features of the present invention. The present invention may also be a sub-combination of the features described above.

### BRIEF DESCRIPTION OF THE DRAWINGS

FIG. 1is a schematic illustration showing a use state of an authentication system according to one embodiment of the present invention.

FIG. 2 is a block diagram showing a configuration of an authentication apparatus.

FIG. 3 is a table showing data configuration of an authentication information holding unit.

FIG. 4 is a table showing data configuration of a reference value holding unit.

FIG. 5 is a flowchart explaining an example of an operation when the authentication apparatus certifies the right person.

FIG. 6 is a flowchart explaining the other example of the operation when the authentication apparatus certifies the right person.

FIG. 7 is a table showing data configuration of the authentication information holding unit in the authentication apparatus in a first transformation example.

FIG. 8 is a flow chart when the authentication apparatus certifies the right person in the first transformation example.

FIG. 9 is a block diagram showing a configuration of an IC card according to a second transformation example.

FIG. 10 is a flowchart explaining the right person authentication process performed by the authentication system in the second transformation example.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

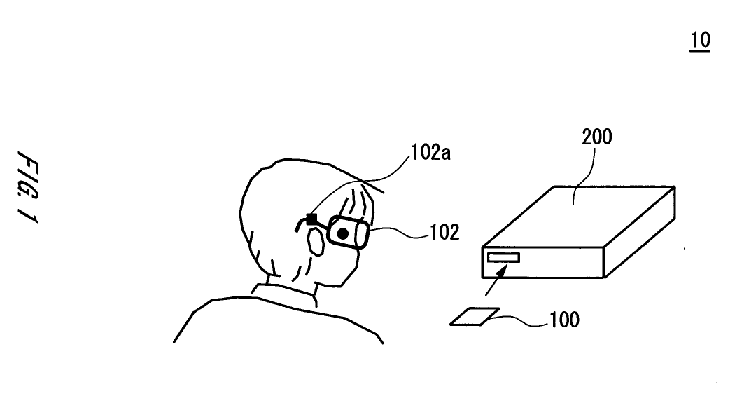

FIG. 1 is a schematic illustration showing a use state of an authentication system 10 according to one embodiment of the present invention. The authentication system 10 comprises an IC card 100 and an IC tag 102a, and an authentication apparatus 200. The IC card 100 and the IC tag 102a are an example of an article for authentication.

The IC card 100 holds an identification information for identifying the right person and a private information of the right person. The identification information is, for example, ID of the right person, a bank card information or a credit card information, and the private information is, for example, a medical treatment information of the right person.

The IC tag 102a is attached to, for example, a portable article 102 selected by the right person. The portable article 102 is an article, such as glasses, that the portability by the right person is high. The IC tag 102a holds an authentication information, and outputs the authentication information to outside by radio by using electromagnetic waves transmitted by the authentication apparatus 200 as an energy source.

When the right person is certified, the authentication apparatus 200 reads out the identification information from the IC card 100 by contact types. In addition, the authentication apparatus 200 acquires the authentication information from the IC tag 102a by radio. In this case, the authentication apparatus 200 may acquire the identification information from the IC card 100 by radio.

The authentication apparatus 200 certifies the right person after acquiring the identification information from the IC card 100 and the authentication information from the IC tag 102a. Therefore, even if improper person acquires the IC card 100, improper person cannot pretend to be the right person unless the portable article 102 is possessed. Furthermore, the authentication apparatus 200 can certify the right person by only carrying the IC card 100 and the portable article 102 with the right person. Therefore, this is not burden to the right person.

In addition, the right person carries one portable article 102 in FIG. 1, but may carry a plurality of portable articles 102. In addition, the authentication apparatus 200 may set on condition for a personal authentication that the apparatus receives the authentication information from a plurality of IC tags 102a attached to each of the plurality of portable articles 102 except the IC card 100. Furthermore, after the personal authentication, the authentication apparatus 200 may decode an encoded information.

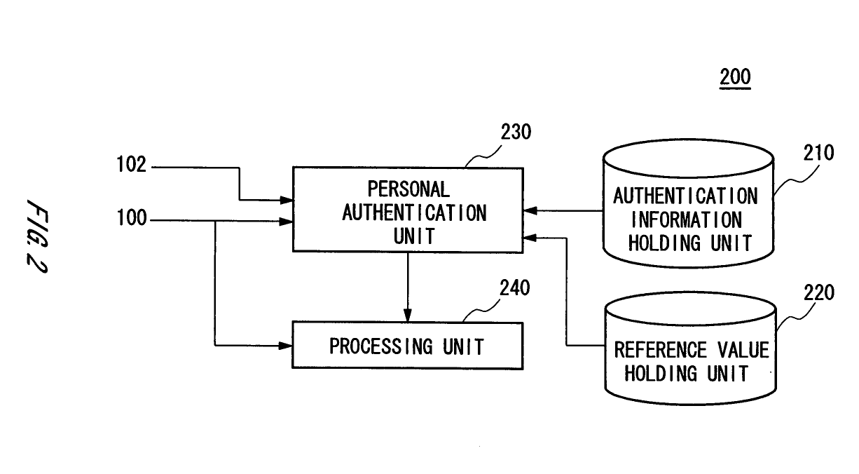

FIG. 2 shows a configuration of the authentication apparatus 200. The authentication apparatus 200 comprises an authentication information holding unit 210, a reference value holding unit 220, a personal authentication unit 230, and a processing unit 240. The personal authentication unit 230 serves also as an authentication information receiving unit.

The authentication information holding unit 210 holds the identification information of the IC card 100 and the plurality of authentication information of each IC tag 102a corresponding to the identification information. The reference value holding unit 220 holds a reference number of the authentication information necessary to the personal authentication. The personal authentication unit 230 performs authentication process for the right person. The processing unit 240 performs a desired process using the individual information of the IC card 100 after the personal authentication unit 230 has certified the right person.

In addition, the details of data configurations of the authentication information holding unit 210 and the reference value holding unit 220 are described below using tables. Furthermore, the details of operations of the personal authentication unit 230 and the processing unit 240 are described below using flowcharts.

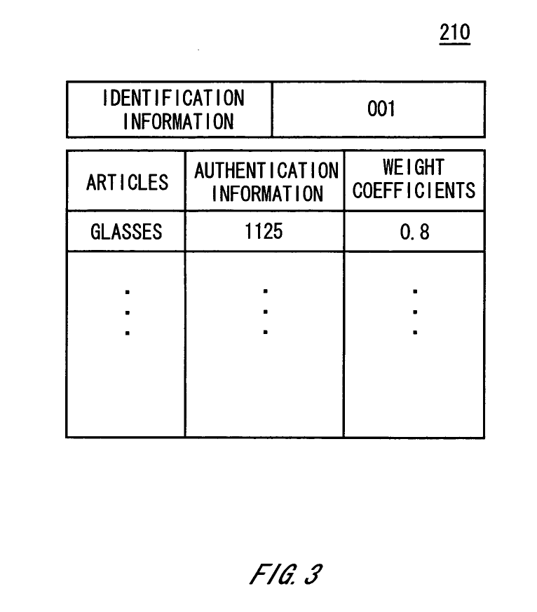

FIG. 3 is a table showing data configuration of the authentication information holding unit 210. The authentication information holding unit 210 holds names of the articles for authentication and the authentication information of the IC tags 102a of the articles for authentication corresponding to the identification information of the IC card 100.

In addition, the authentication information holding unit 210 holds weight coefficients showing weights of each authentication information. The weight coefficients are decided based upon, for example, the probability that the right person carries the portable articles 102. Furthermore, the weight coefficients are used when the personal authentication unit 230 certifies the right person, and the use method thereof is described below using a flowchart.

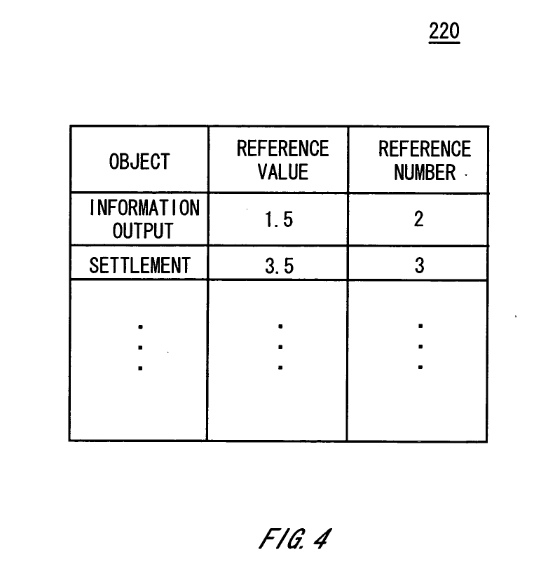

FIG. 4 is a table showing data configuration of the reference value holding unit 220. The reference value holding unit 220 holds an object information showing an object of the personal authentication, for example, the reference number of the authentication information necessary to the personal authentication in response to the desired procedure by the right person.

In addition, the reference value holding unit 220 holds the reference value, namely, the sum of the weight coefficients of the authentication information necessary to the personal authentication in response to the object information. An use method of this reference value is described below using a flowchart.

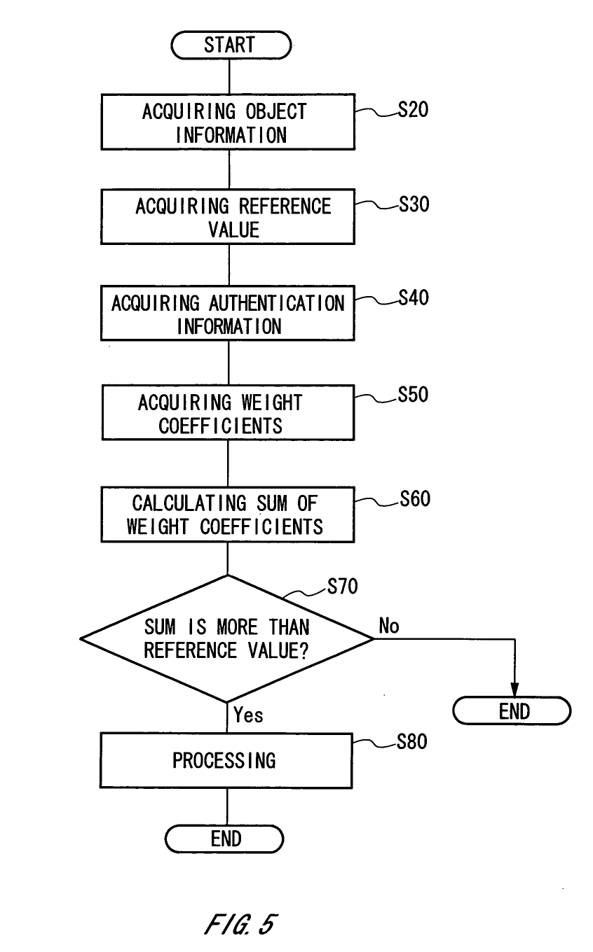

FIG. 5 is a flowchart explaining an example of an operation when the authentication apparatus 200 certifies the right person. In this example, the personal authentication unit 230 of the authentication apparatus 200 certifies the right person by using the weight coefficients of the authentication information holding unit 210 and the reference value of the reference value holding unit 220.

The right person inserts the IC card 100 into the authentication apparatus 200, and inputs the object information showing an object of the personal authentication by way of an input means such as a touch panel. The personal authentication unit 230 acquires the input object information (S20). After that, the personal authentication unit 230 reads the reference value corresponding to the acquired object information from the reference value holding unit 220, and sets the read reference value as a reference value for the personal authentication (S30).

Next, the personal authentication unit 230 reads out the identification information from the IC card 100, and at the same time reads out the authentication information by radio from the IC tags 102a of each of the portable articles 102 carried by the right person (S40). In addition, the personal authentication unit 230 selects the authentication information from the authentication information holding unit 210 based upon the identification information. After that, the personal authentication unit 230 confirms whether or not the authentication information read by radio is identical with the authentication information selected from the authentication information holding unit 210. The personal authentication unit 230 reads out the weight coefficients corresponding to the confirmed authentication information from the authentication information holding unit 210 (S50).

The personal authentication unit 230 calculates the sum of the read weight coefficients (S60), and certifies the right person when the calculated sum is greater than the set reference value (S70: Yes). When the right person is certified, the processing unit 240 carries out a process on the basis of the object information (S80). This process includes also the decoding of the encoded information depending on the object.

As explained above, the authentication apparatus 200 certifies the right person when the sum of the weight coefficients corresponding to the acquired authentication information is greater than the reference value. For this reason, when possessing the article for authentication with high importance such as the IC card, the person can certify himself through the authentication apparatus 200 even if the person does not carry several articles for authentication with low importance.

In addition, the reference value is decided based upon the object information, for example, a kind of a procedure. For example, when increasing the reference value corresponding to a procedure of high importance, the person who desires the procedure of high importance needs to carry the IC card 100 and other authentication articles. Therefore, even if improper person acquires the IC card, this improper person cannot perform the procedure of high importance like the right person.

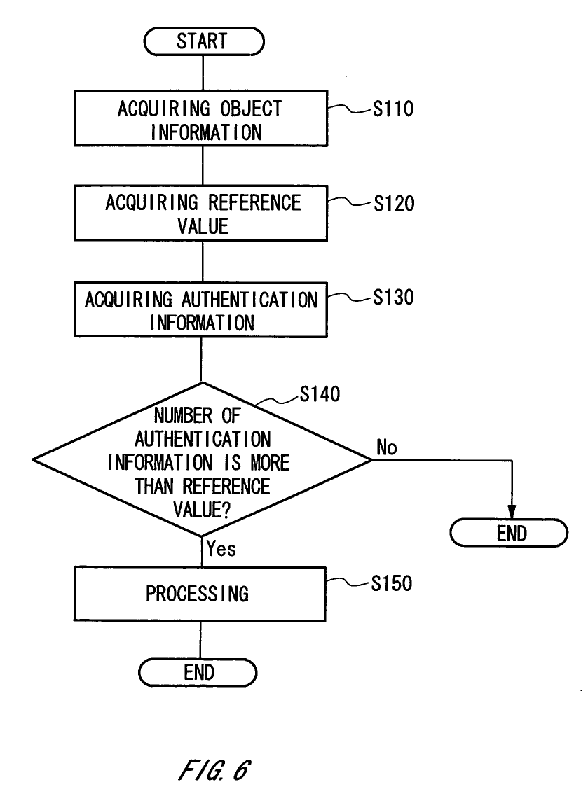

FIG. 6 is a flowchart explaining an example of an operation when the authentication apparatus 200 certifies the right person. In this example, the personal authentication unit 230 of the authentication apparatus 200 certifies the right person using the reference number of the reference value holding unit 200.

The right person inserts the IC card 100 into the authentication apparatus 200, and inputs the object information showing an object of the personal authentication to the authentication apparatus 200 by way of input means such as a touch panel. The personal authentication unit 230 acquires the input object information (S110). After that, the personal authentication unit 230 reads the reference number corresponding to the acquired object information from the reference value holding unit 220, and sets the read reference value as a value of the authentication information for the personal authentication (S120).

Next, the personal authentication unit 230 reads out the identification information from the IC card 100, and at the same time reads out the authentication information by radio from the IC tags 102a of each of the portable articles 102 carried by the right person (S130). In addition, the personal authentication unit 230 selects the authentication information, which should be held by the portable article 102 of the right person, from the authentication information holding unit 210 based upon the identification information read from the IC card 100. After that, the personal authentication unit 230 confirms whether or not the authentication information read by radio is identical with the authentication information selected from the authentication information holding unit 210 (S140). The personal authentication unit 230 certifies the right person when the value of the same authentication information is greater than the set reference number (S140: Yes). When the right person was certified, the processing unit 240 carries out a process on the basis of the object information (S150).

According to this example, the authentication apparatus 200 certifies the right person when the value of the acquired authentication information is greater than the set reference value. Therefore, when several reference numbers are set, it is difficult for improper person to pretend to be and behave like the right person even if the IC card 100 and some portable articles 102 are acquired.

Furthermore, in the first transformation example, the authentication apparatus 200 may set on condition for a personal authentication that the apparatus receives the authentication information from the IC card 100 and receives the authentication information from anything of the other portable articles 102. In this second transformation example, each of the plurality of portable articles holds the same authentication information, and serves as an assistance of the IC card 100 respectively.

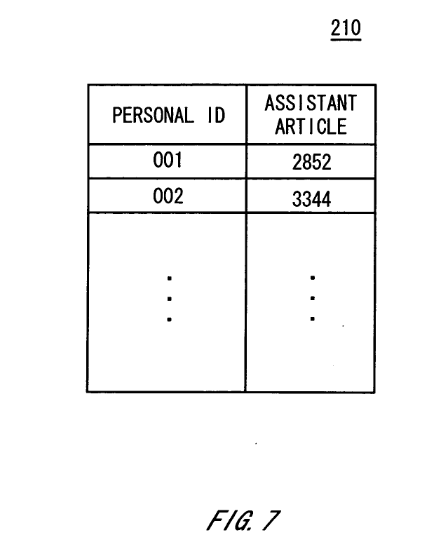

FIG. 7 is a table showing data configuration of the authentication information holding unit 210 of the authentication apparatus 200 in this transformation example. The authentication information holding unit 210 holds one authentication information in response to the identification information. This authentication information is the common information that the IC tags 102a of each portable article 102 should hold.

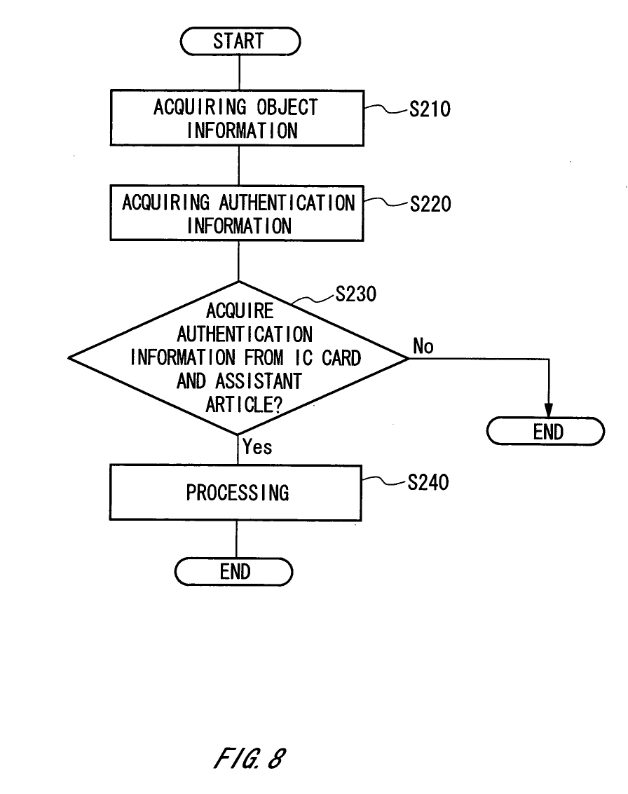

FIG. 8 is a flowchart when the authentication apparatus 200 certifies the right person in the transformation example. The right person inserts the IC card 100 into the authentication apparatus 200, and inputs the object information showing an object of the personal authentication to the authentication apparatus 200 by way of input means such as a touch panel. The personal authentication unit 230 acquires the object information (S210).

Next, the personal authentication unit 230 reads out the identification information from the IC card 100, and at the same time reads out the authentication information by radio from the IC tags 102a of the portable articles 102 carried by the right person (S220).

The personal authentication unit 230 certifies the right person when it is judged to have received the authentication information corresponding to the identification information from anything of the IC tags 102a (S230: Yes). After that, when the right person was certified, the processing unit 240 carries out process on the basis of the object information (S240).

As explained above, in this transformation example, the authentication apparatus 200 certifies the right person when the right person carries the IC card 100 and some of the portable articles 102 or the assistances. Therefore, even if improper person acquires the IC card 100, the authentication apparatus 200 does not certify improper person as the right person. In addition, the probability that the right person is not certified is low, because it is preferable if the right person carries anything of the portable articles 102.

Next, the second transformation example of the embodiment is described. In this transformation example, the IC card 100 and the IC tag 102a of the portable article 102 hold an authentication information for the card and an authentication information for the article respectively. The IC card 100 receives the authentication information for the article from the portable article 102 during the personal authentication. After that, the IC card 100 generates an authentication key by means of the authentication information for the card and the authentication information for the article, and transmits the key to the authentication apparatus 200. The authentication apparatus 200 performs the authentication process.

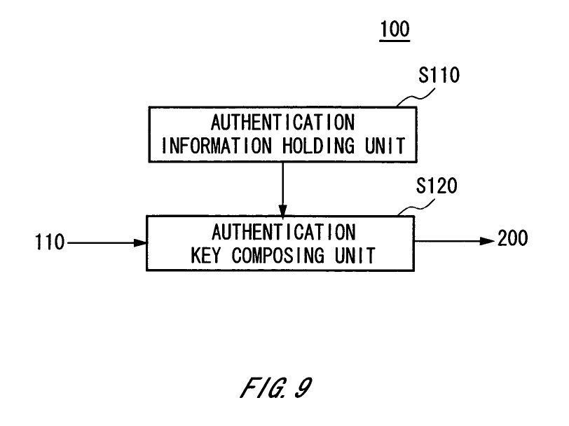

FIG. 9 is a block diagram showing a configuration of the IC card 100 according to this transformation example. The IC card 100 comprises an authentication information holding unit 110 and an authentication key composing unit 120. The authentication information holding unit 110 holds the authentication information for the card in advance. The authentication key composing unit 120 receives the authentication information for the article from the IC tag 102a of the portable article 102. The authentication key is generated based upon the authentication information for the card and the authentication information for the article, and the generated key is output to the authentication apparatus 200.

The configuration of the authentication apparatus 200 is generally similar to the embodiment except that the authentication information holding unit 210 stores the authentication key in response to ID of the right person.

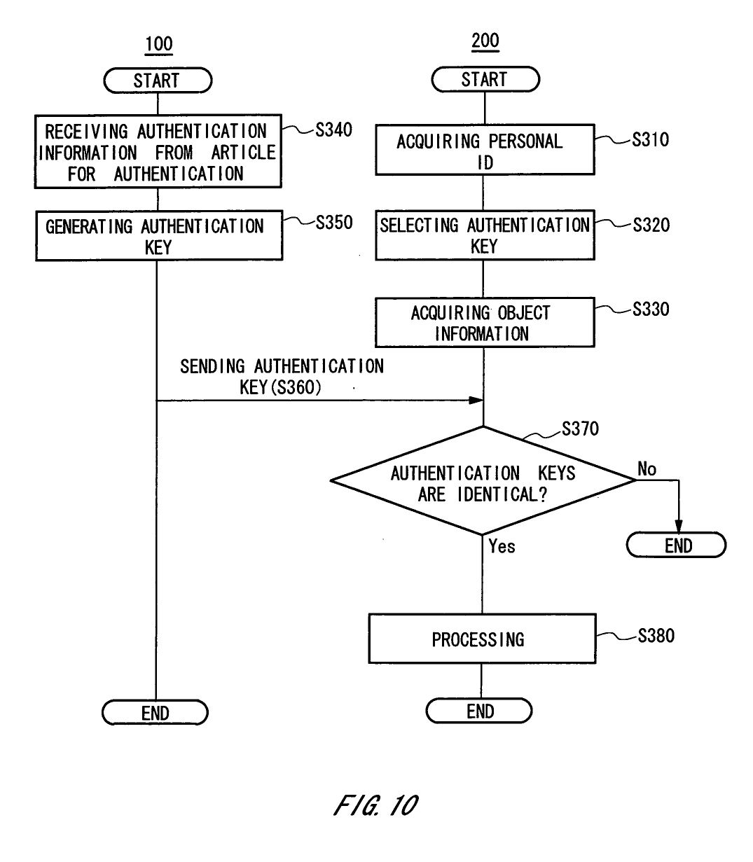

FIG. 10 is a flowchart explaining the personal authentication process performed by the authentication system 10 in the transformation example. At first, the right person inputs a personal ID and an object information into the authentication apparatus 200. The personal authentication unit 230 of the authentication apparatus 200 acquires the personal ID (S310), and selects an authentication key from the authentication information holding unit 210 based upon the acquired personal ID (S320). In addition, the processing unit 240 acquires the object information (S330).

Furthermore, the right person inserts the IC card 100 into a card reader 20. The card reader 20 propagates electromagnetic waves in order to operate the IC tags 102a of the portable articles 102. The IC tags 102a operate using the electromagnetic waves propagated by the card reader 20 as an energy source, and outputs the authentication information for the articles to outside by radio. The authentication key composing unit 120 of the IC card 100 receives the authentication information for the articles output by radio (S340), and generates the authentication key using the authentication information for the card and the authentication information for the articles held by the authentication information holding unit 110 (S350). After that, the authentication key composing unit 120 transmits the authentication key to the authentication apparatus 200 by way of the card reader 20 (S360).

The personal authentication unit 230 of the authentication apparatus 200 certifies the right person when the authentication key received from the IC card 100 is identical with the authentication key selected from the authentication information holding unit 210 (S370). The processing unit 240 processes according to the object information (S380).

As described above, the IC card 100 receives the authentication information for the article held by the IC tag 102a of the portable article 102, and generates the authentication key using the authentication information for the card held by the IC card 100. Therefore, even if improper person acquires the portable article 102, improper person cannot pretend to be and behave like the right person.

In addition, in the case of sending the authentication key generated by the IC card 100 to the authentication apparatus 200, the IC card 100 may not be inserted into the card reader 20. In this case, the IC card 100 transmits the authentication key to the card reader 20 by radio.

Furthermore, the IC card 100 may generate a decoding key, for example, a secret key for decoding the encoded information based upon the authentication information for the card and the authentication information for the article. In this case, the personal authentication unit 230 decodes the encoded information based upon the received decoding key, and certifies the right person in the case of being capable of decoding.

As is apparent from the explanation, according to the present invention, improper person cannot pretend to be and behave like the right person even if improper person acquires an article for the personal authentication. In addition, this is not burden to the right person in the case of the personal authentication.

Although the present invention has been described by way of an exemplary embodiment, it should be understood that those skilled in the art might make many changes and substitutions without departing from the spirit and the scope of the present invention. It is obvious from the definition of the appended claims that embodiments with such modifications also belong to the scope of the present invention.

What is claimed is:

1. An authentication apparatus for performing a personal authentication process, comprising:
an authentication information receiving unit for receiving an authentication information held by each of a plurality of articles for authentication from each of the plurality of articles for authentication carried by a right person, and at the same time communicating with at least one article for authentication by radio; and
a personal authentication unit for performing the personal authentication process using the plurality of authentication information received by said authentication information receiving unit.

2. The authentication apparatus as claimed in claim 1, further comprising an authentication information holding unit for previously holding weight coefficients showing weights of the authentication information in response to each of the plurality of authentication information,
said personal authentication unit acquires the weight coefficient corresponding to the received authentication information from said authentication information holding unit, and certifies the right person when a sum of the acquired weight coefficients is greater than a predetermined reference value.

3. The authentication apparatus as claimed in claim 2, wherein said personal authentication unit decides differently said reference value according to an object of the personal authentication.

4. The authentication apparatus as claimed in claim 1, wherein said personal authentication unit certifies the right person when the value of the received authentication information is more than the predetermined reference number.

5. The authentication apparatus as claimed in claim 4, wherein said personal authentication unit decides said reference number according to an object of the personal authentication.

6. The authentication apparatus as claimed in claim 1, wherein one of the plurality of articles for authentication holds an identification information identifying the right person as said authentication information.

7. The authentication apparatus as claimed in claim 6, wherein the plurality of articles for authentication includes a main article and a plurality of assistant articles,
said plurality of assistant articles holds the same authentication information,
said personal authentication unit certifies the right person when receiving said authentication information from said main article and said authentication information from any one of said assistant articles.

8. An authentication system, comprising:
a plurality of articles for authentication carried by a right person and used to certify the right person; and
an authentication apparatus for performing a personal authentication process, wherein
said each article for authentication holds different authentication information,
said authentication apparatus includes a personal authentication unit for receiving the plurality of authentication information held by said plurality of articles for authentication and certifying the personal himself using the received plurality of authentication information.

9. The authentication system as claimed in claim 8, wherein at least one of said articles for authentication transmits said authentication information to said authentication apparatus by radio using an energy by an electromagnetic wave acquired from outside.

10. The authentication system as claimed in claim 8, wherein one of said articles for authentication includes an authentication key generating unit for receiving said authentication information held by that article for authentication from the other articles for authentication, and generating an authentication key for the personal authentication based upon the received authentication information and the authentication information held by that article for authentication in advance,
said personal authentication unit of said authentication apparatus receives said authentication key from said article for authentication that has generated said authentication key, and certifies the right person using said authentication key.

11. The authentication system as claimed in claim 10, wherein said article for authentication generates a decoding key for decoding an encoded information using said authentication key,
said personal authentication unit performs a decoding process using said decoding key.
